(19) United States
(12) Patent Application Publication
(10) Pub. No.: US 2005/0135788 A1
(43) Pub. Date: Jun. 23, 2005

(54) Image encoder and recorder

(75) Inventors: Hiromasa Fujii, Hitachinaka (JP); Yasushi Takagi, Mito (JP); Yuji Sato, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/920,980

(22) Filed: Aug. 18, 2004

(30) Foreign Application Priority Data
Dec. 19, 2003 (JP) 2003-421951

(51) Int. Cl. H04N 7/26

(52) U.S. Cl. 386/112

(57) ABSTRACT

A recording apparatus is provided in which, when image signals are inputted from a plurality of channels and compressed and encoded before being recorded on a medium, the slow-varying-image signals are improved in their quality even if the numbers of bits for the image signals are decreased and they are recorded on the medium for a long time. The image signals inputted are converted into a single-channel image signal, sorted to be a group of a certain number of frames for each channel, and compressed and encoded for each group of a certain number of frames. When an image quality is fixed, the number of bits for the reference image at the encoding time is kept constant, but the number of bits for the difference image at that time is changed.

### BACKGROUND OF THE INVENTION

The present invention relates to an image signal encoding apparatus for suitably compressing and encoding the image signals derived from a plurality of cameras, and to an image signal recording apparatus for recording the compressed and encoded image signals on a recording medium.

In the anticrime/security monitoring system using video cameras, a plurality of cameras are often connected to a single recorder so as to simultaneously monitor at multiple points. In this case, when the recorder is constructed to record a plurality of image signals at a time, its recording capacity is required to increase in proportion to the number of cameras, thus leading to high cost.

Thus, there is known a system in which the parallel image signals from a plurality of cameras are sequentially switched every frames to form a time series signal, or a single-channel signal, and a predetermined number of frames sorted for each camera are compressed and encoded as a unit and recorded on a recording medium. According to this system, since frame correlation can be used, the recording rate per camera can be reduced and long-time recording can be performed without increasing the capacity of the recording medium, (for example, see JP-A-2001-103471).

### SUMMARY OF THE INVENTION

In the above prior art, however, when the recording rate is decreased for long-time recording, the compression ratio of all frames is required to increase, resulting in the fact that the compression ratio of the reference images is increased. In the monitoring application in which the cameras are each often used at the same angle of view for a long time to produce slow-varying images that are to be recorded, there is no description about the effect of the increased compression ratio of reference images on the quality of the slow-varying portions.

It is an objective of the invention to provide an image encoder and recorder capable of solving the above problem and thus improving the image quality of the slow-varying portions even in longer-time recording by keeping the number of bits constant for the reference image and changing it for the difference image to thereby assuring the quality of the reference image and to decrease the average number of bits.

In order to solve the above problem, according to the first invention, there is provided a video signal encoding apparatus having a selecting module which sequentially selects one of input image signals fed from a plurality of channels in synchronism with the frame of the input image signals and converts the input image signals into a single-channel image signal, a sorting module which sorts the image signals of the single-channel image signal to be a group of a fixed number of frames for each channel, an encoding module which compresses and encodes each of the groups of frames of the sorted image signals that includes one reference image and one or more difference images, and a controlling module which controls the numbers of bits for the reference image and difference image compressed and encoded by the encoding module to be fixed as target values, whereby a plurality of combinations of the target numbers of bits for the reference image and for the difference image can be obtained and used to make image quality setting when an image quality is fixed. Thus, since the numbers of bits can be selected when an image quality is fixed, the image quality and recording time can be selected depending upon the situations in which the cameras are placed. For example, the number of bits for the slow-varying camera image is decreased so that it can be recorded for a long time.

In addition, there is provided an image signal encoding apparatus according to the above apparatus wherein a combination table for the combinations of the target numbers of bits is provided to have constant target numbers of bits for the reference image but variable target numbers of bits for the difference image depending upon a fixed image quality. Thus, when a low quality is selected, the number of bits for the reference image is kept constant, but that for the difference image is decreased so that the total recording rate can be reduced. Therefore, even when a low quality is selected, the image quality for the reference image can be kept good, and the image can be recorded for a long time so that the slow-varying image can be improved in its quality.

The image signal encoding apparatus is further constructed to be capable of selecting any image quality for each of the input channels. Thus, an image quality can be fixed for each channel, and hence the quality can be changed depending on the situations in which the cameras are placed. For example, when the cameras installed is a combination of cameras on which the image varies quickly or frequently and cameras on which the image varies slowly, a low quality is selected only for the channels of cameras on which the image varies slowly, thereby obtaining the effect that the image can be recorded for a long time.

The apparatus is further constructed to dynamically change the frame interval of the image signal encoded on each channel and to change the image quality according to the frame interval. Thus, since the channel fixed to have a wide frame interval can be increased in its image quality, it is possible to improve the image quality of the wide-interval channel that is apt to have quick varying images as compared with the narrow-interval channel.

According to the second invention, there is provided an image signal recording apparatus having a selecting module which sequentially selects one of input image signals fed from a plurality of channels in synchronism with the frame of the input image signals and converts the input image signals into a single-channel image signal, a sorting module which sorts the image signals of the single-channel image signal to be a group of a fixed number of frames for each channel, an encoding module which compresses and encodes each of the groups of frames of the sorted image signals that includes one reference image and one or more difference images, a controlling module which controls the numbers of bits for the reference image and difference image compressed and encoded by the encoding module to be fixed as target values, and a recording module which records the compressed and encoded image signals on a medium, whereby a plurality of combinations of the target numbers of bits for the reference image and for the difference image can be obtained and used to make image quality setting when an image quality is fixed. Thus, since the number of bits can be changed at the time of fixing a quality, the image quality and recording time can be fixed to arbitrary values depending upon the situations in which the cameras are placed. For example, for the camera of slow-varying image, the number of bits is decreased so that the image can be recorded for a long time.

This recording apparatus is further constructed to provide a combination table for the combinations of the target numbers of bits to have constant target numbers of bits for the reference image but variable target numbers of bits for the difference image depending upon a fixed image quality. Thus, when a low quality is selected, the number of bits for the reference image is kept constant, but that for the difference image is decreased so that the total recording rate can be decreased. Therefore, even when a low quality is selected, the quality of the reference image can be kept better and the image can be recorded for a long time, so that the quality of slow-varying images can be improved.

The recording apparatus is further constructed to be capable of selecting a quality for each channel input. Thus, it is possible to fix the image quality at any value for each channel and change the quality according to the situations in which the cameras are placed.

The recording apparatus is further constructed to dynamically change the frame interval of the image signal encoded on each channel, and change the image quality according to the frame interval. Thus, by increasing the image quality of the channel on which the frame interval is selected to be wide, it is possible to improve the image quality of the wide-frame-interval channel that is apt to have quick-varying images as compared with the case in which the frame interval is narrow.

According to the invention, even if the image quality is reduced for longer time recording, the slow-varying image on the camera can be improved in its quality.

In addition, when the cameras include cameras to which a frequently changing moving image is entered, and cameras to which a slow-varying image is applied, only the cameras to which the slow-varying image is entered are fixed to a low quality so that the image can be recorded for a longer time.

Moreover, by increasing the image quality of the channel on which the frame interval is fixed to be wide, it is possible to improve the image quality of the wide-frame-interval channel that is apt to have a quick-varying image as compared with the narrow-frame-interval channel.

As described above, a monitoring system according to the invention has the effect that the image on the monitor can be recorded with higher quality even when it is recorded for a long time.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of the whole image signal encoder and recorder according to one embodiment of the invention.

FIG. 2 is a block diagram of the detailed construction of a main part of the embodiment of FIG. 1.

FIGS. 3A-3E are diagrams of frames showing the signal processing in the embodiment of FIG. 1.

FIG. 4 is diagrams of frames showing the signal processing in the embodiment of FIG. 1.

FIG. 5 is a diagram of frames showing the signal processing in the embodiment of FIG. 1.

FIG. 6 is a table showing an example of values set for quality in the prior art of the embodiment of FIG. 1.

FIG. 7 is a table showing an example of values set for quality in the embodiment of FIG. 1.

FIG. 8 is a table showing an example of values set for quality and intervals of recorded frames in the embodiment of the invention of FIG. 1.

### DETAILED DESCRIPTION OF THE EMBODIMENT

An embodiment of the invention will be described with reference to the drawings.

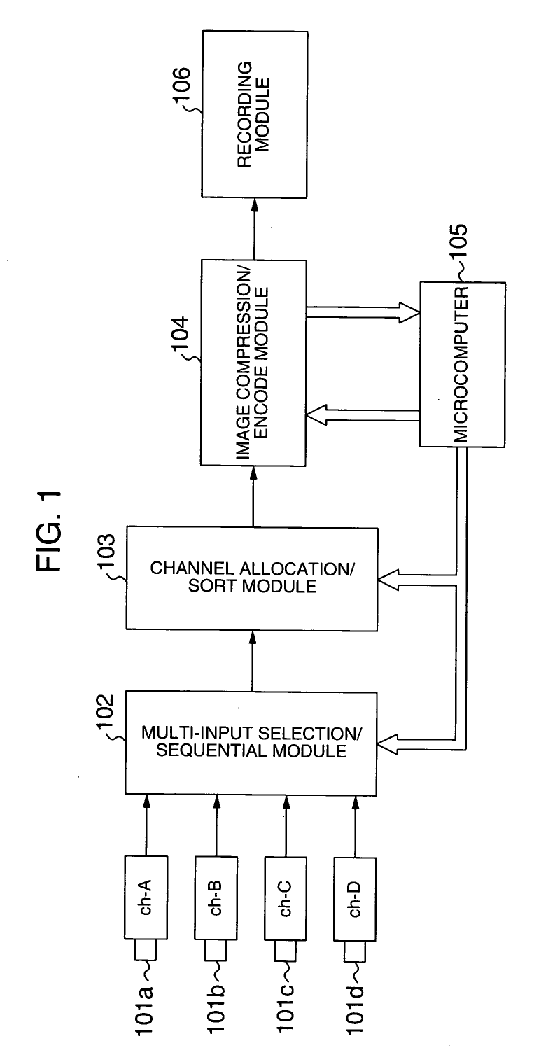

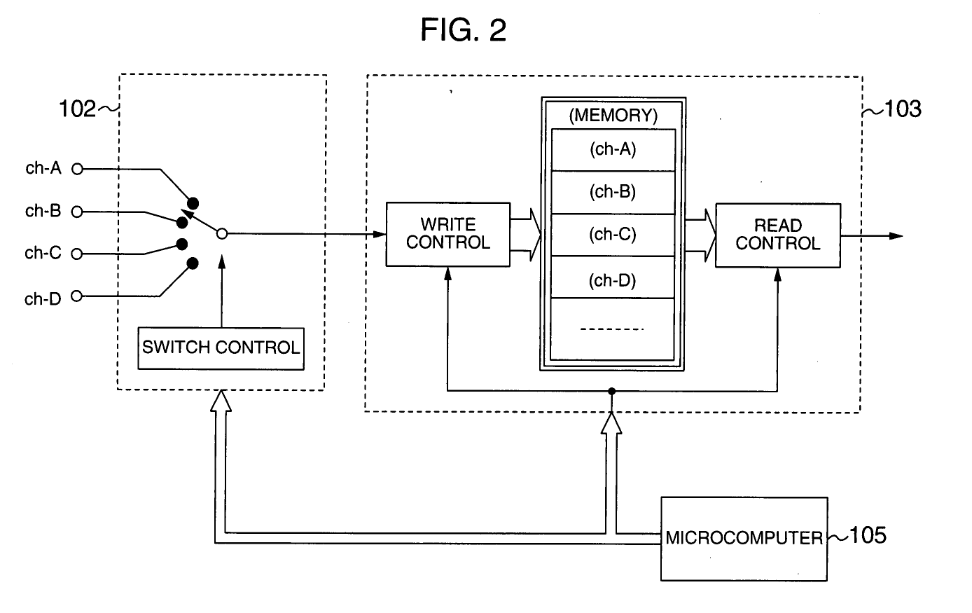

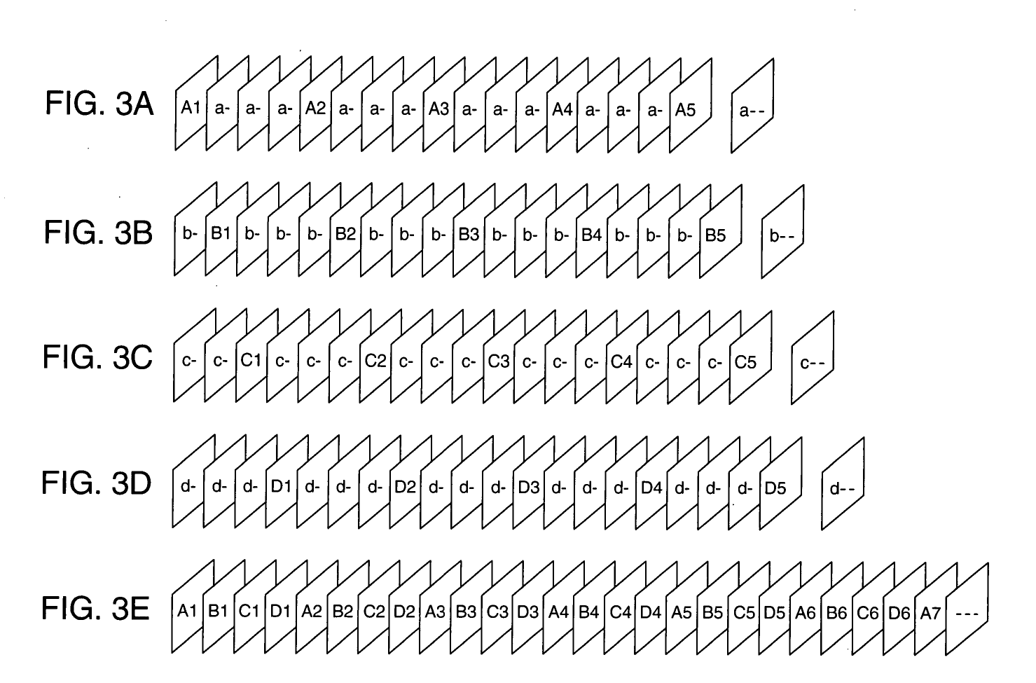

FIG. 1 is a block diagram of the whole image encoder and recorder of one embodiment according to the invention. FIG. 2 is a block diagram of the detailed construction of a main part of the construction shown in FIG. 1. FIGS. 3 through 5 are diagrams of frames showing the signal processing in each element block. Referring to FIG. 1, there are shown video cameras 101a˜101d for channels ch-A˜ch-D (here, only four channels are shown), a multi-input selection/sequential module 102 that is formed of a frame switch/multiplexer, a channel allocation/sort module 103 formed of a frame memory, an image compression/encode module 104, a system controlling microcomputer 105, and a recording module 106.

The cameras 101a-101d are installed to monitor the images of the scenes at different points. Each of the cameras generates an image signal at a predetermined frame rate (for example, 30 fps (frames per second) in the NTSC standards), and supplies it to the multi-input selection/sequential module 102. The controlling microcomputer 105 controls the multi-input selection/sequential module 102 to select one of the channels with a period of frame as shown in FIG. 2 and to thereby convert the multi-channel signals into a single-channel signal which is produced from the module 102. The production of this single-channel signal makes it possible to reduce the circuit scale of the connection between the channel allocation/sort module 103 and the multi-input selection/sequential module 102.

FIGS. 3A-3E show an example of input signals to and an output signal from the multi-input selection/sequential module 102. FIG. 3A shows an image signal of frames fed from the camera 101a of channel ch-A at a frame rate of A1, a-, a-, a-, A2, a-, a- . . . . Similarly, FIG. 3B shows an image signal of frames fed from the camera 101b of channel ch-B, FIG. 3C an image signal of frames fed from the camera 101c of channel ch-C, and FIG. 3D an image signal of frames fed from the camera 101d of channel ch-D. The image signals of frames (FIGS. 3A˜3D) fed from the four channels of cameras 101a˜101d are sequentially switched to produce a sequential single-channel image signal of frames as shown in FIG. 3E. As illustrated in FIG. 3E, this single-channel image signal is a sequence of four channels as “A1, B1, C1, D1, A2, B2 . . . ”. The input frames indicated by lower case letters with “-” attached such as “a-, b-” in FIGS. 3A-3D are removed by thinning by the multi-input selection/sequential module 102. Although the cameras 101a of channel ch-A through 101d of channel ch-D are sequentially switched at equal intervals as shown in FIGS. 3A-3D, the switching intervals can be changed at each channel as long as the frame rate of the output frames shown in FIG. 3E does not exceed 30 fps. Thus, by setting the image quality of the wide frame-interval channels to be high, it is possible to improve the image quality of the wide frame-interval channels of which the images are apt to vary than the narrow frame-interval ones.

The data of sequential image signal containing a plurality of channels produced from the multi-input selection/sequential module 102 is fed to the channel allocation/sort module 103. The channel allocation/sort module 103 is formed of a memory, a write control module and a read control module.

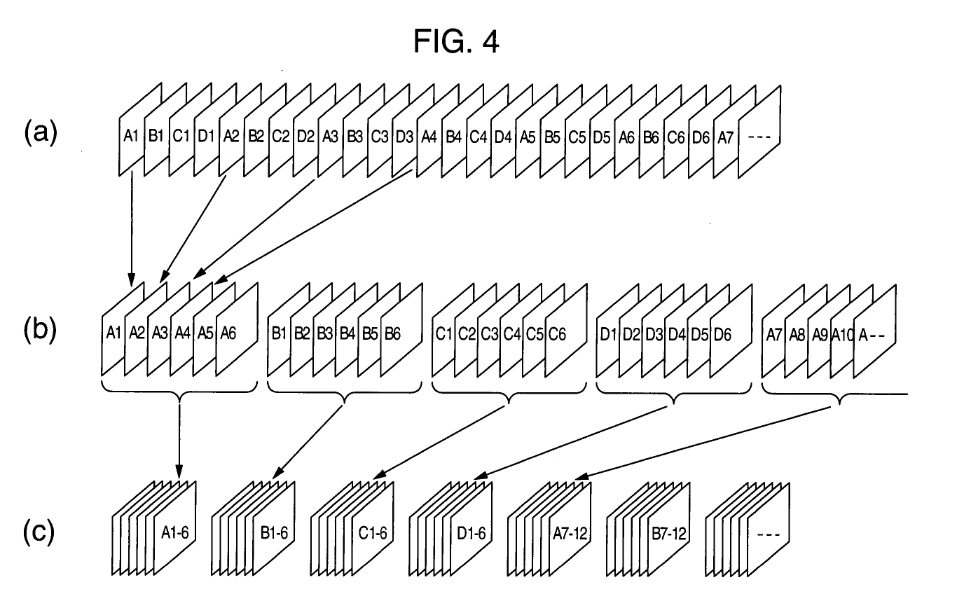

FIG. 4 shows the signal processing in the channel allocation/sort module 103. The sequential single-channel image signal of frames, as shown in FIG. 3E, produced from the multi-input selection/sequential module 102 is supplied as the image signal data shown in step (a) of FIG. 4 and stored in the memory address areas allocated to each channel, or sorted so that the different channels can be separately stored (steps (a)-(c) in FIG. 4). Step (b) of FIG. 4 shows an example of GOPs (Groups Of Pictures) given for each channel and each of which includes six frames.

In other words, the image frames “A1, A2, . . . ” from the camera 101a of channel ch-A are stored in the address area for channel ch-A. Similarly, the image frames “B1, B2, . . . ”, “C1, C2, . . . ” and “D1, D2, . . . ” from the cameras 101b˜101d of channels ch-B˜ch-D are stored in the address areas for channels ch-B˜ch-D, respectively. At this time, the controlling microcomputer 105 controls the memory to recognize the image channel to be written and to select the storage area in synchronism with the channel switching control operation on the multi-input selection/sequential module 102.

The controlling microcomputer 105 also controls the memory to reads out the image signal (data) of the frame number corresponding to the group of pictures for each channel at a time, and supplies it to the image compression/encode module 104 (step (b) to step (c) in FIG. 4). Although the group of pictures (GOP) is formed of six frames for simplicity in FIG. 4, the number of frames is suitably selected according to the use or the system structure. Step (c) in FIG. 4 shows an example of each compressed and encoded GOP that contains the first frame as the reference image, and the second to sixth frames (five frames) as the difference images.

The image compression/encode module 104 makes compression/encode processing on the input data according to a technique such as MPEG (Moving Picture Experts Group) to produce a train of encoded data (bit stream) as the output data. The bit stream is recorded on a recording medium of the recording module 106. Alternatively, the bit stream can be transmitted to an uncompress/decode module or an external apparatus.

In the image compression/encode module 104, when it makes compression/encode operation, the first frame of each GOP is produced as a reference image by interframe compression and encoding, and the second to sixth frames are produced as difference images by interframe compression and encoding of the difference to the previous image, respectively. The controlling microcomputer 105 makes the so-called bit rate control for adjusting the number of generated bits in order to meet the target number of bits specified previously. Unless otherwise stated, it is assumed that the following bit rate control includes the control that is compliant with the MPEG2 standard and the construction to achieve this control. In this embodiment, since images of a plurality of sequential channels are treated, the compression/encode module 104 is constructed not to inherit the bit rate control between the GOPs of different channels of which the image frames are adjacent to each other. In other words, as each GOP is shown in step (c) of FIG. 4, the compression/encode processing is configured between the GOPs of frames such as A1-6, A7-12 of the same channel, but not configured between different GOPs of frames such as A1-6 and B1-6.

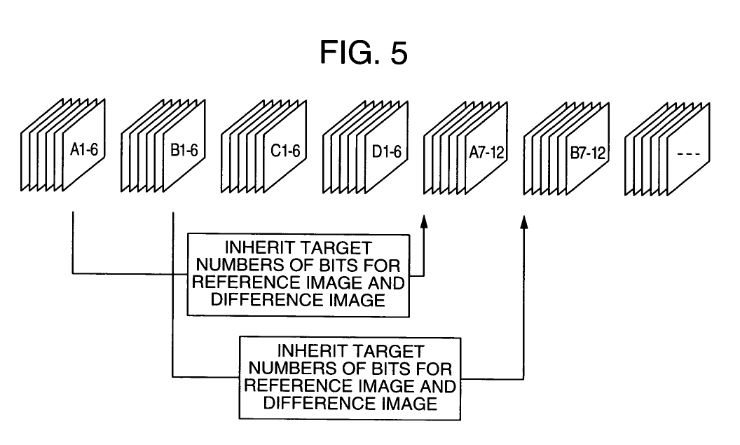

FIG. 5 shows the correlation of the numbers of bits between GOPs of the same channel in the image compression/encode module 104. The controlling microcomputer 105 acquires the target numbers of bits of the reference image and difference image each time one GOP is completed to encode, keeps them for each channel, and supplies the corresponding ones to the image compression/encode module 104 when the compression/encode operation for the current channel starts to make, so that a virtual compression/encode operation can be made equivalent to the continuous images of each channel. Thus, a different image quality can be established for each channel by selecting a different target number of bits for each channel and not inheriting the target number of bits of different GOPs of channels.

Here, the quality setting will be described with reference to FIG. 1. Input module (not shown) to this image signal encoder and recorder is used and its menu function is used to select and fix the number of cameras connected (the number of channels), the image quality (high quality, standard quality and low quality) of each camera and the number of frames. When the quality is fixed, the controlling microcomputer 105 acquires the target numbers of bits of the reference image and difference image corresponding to the fixed quality from the combinations of quality values as a plurality of target numbers of bits of the reference image and different image stored previously, and changes the bit rate control on the image compression/encode module 104.

The settings of quality will be described in detail.

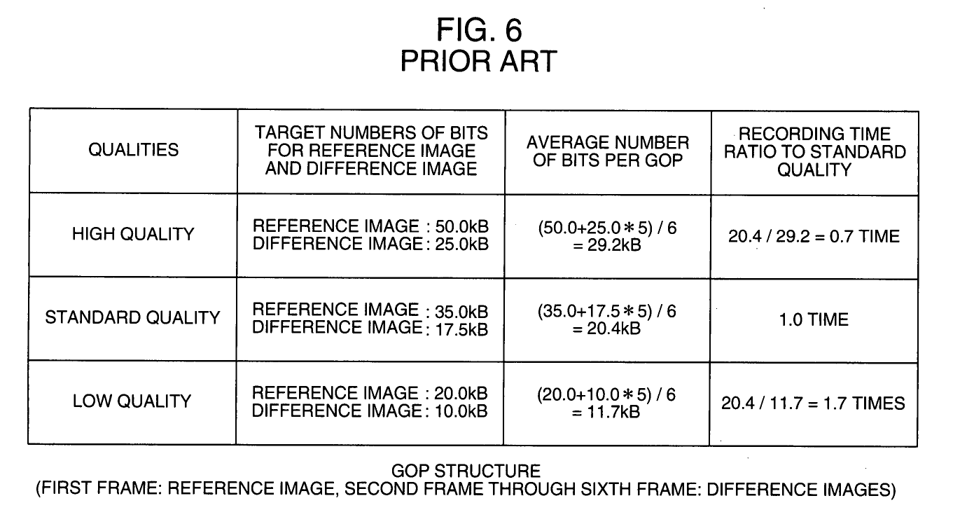

The settings of quality in the prior art will be first mentioned. FIG. 6 shows an example of the settings of image quality in the prior art. In the prior art, the target number of bits for the difference image is fixed to ½ that for the reference image even in any image quality. When the target number of bits for the reference image is changed for each selection of any image quality, the target number of bits for the difference image is required to change. Thus the average number of bits per GOP is also changed. In other words, for high quality, the target number of bits for the reference image is selected to be 50.0 kB for increasing the quality, and hence the target number of bits for the difference image is fixed to ½ that, or 25.0 kB. The average number of bits per GOP is thus 29.2 kB. The recording time ratio to the standard quality is 0.7. For low quality, the target number of bits for the reference image is selected to be 20.0 kB, and hence the target number of bits for the difference image is fixed to ½ that, or 10.0 kB. The average number of bits per GOP is 11.7 kB. The recording time) ratio to the standard quality is 1.7. However, for low quality, since the target number of bits for the reference image is fixed to be as low as 20.0 kB, the number of bits for the reference image is low even when the camera on which the image varies slowly, leading to low image quality.

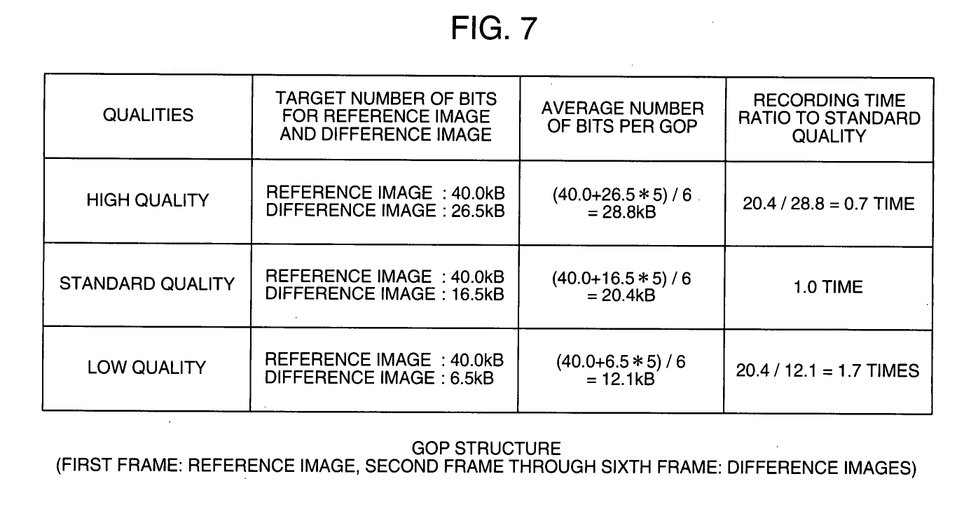

FIG. 7 shows an example of the settings of image quality in this invention. The target number of bits for the reference image of each quality is the same, but the target number of bits for the difference image is changed for different qualities. For example, for low quality, the target number of bits for the reference image is 40.0 kB, and the target number for the difference image is 6.5 kB that is smaller than that for the standard quality so that the average number of bits per GOP can be reduced. Thus, if the image on the camera varies slowly, it can be recorded for a longer time. For high quality, the target number of bits for the reference image is 40.0 kB, but the target number for the difference image is 22.5 kB that is larger than that for the standard quality, thus improving the quality of moving portions. According to the invention, the average number of bits per GOP for low quality is about the same as that in the prior art shown in FIG. 6 so that long time recording can be assured, and the number of bits for the reference image is increased so that the slow-varying image on the camera can be improved in its quality.

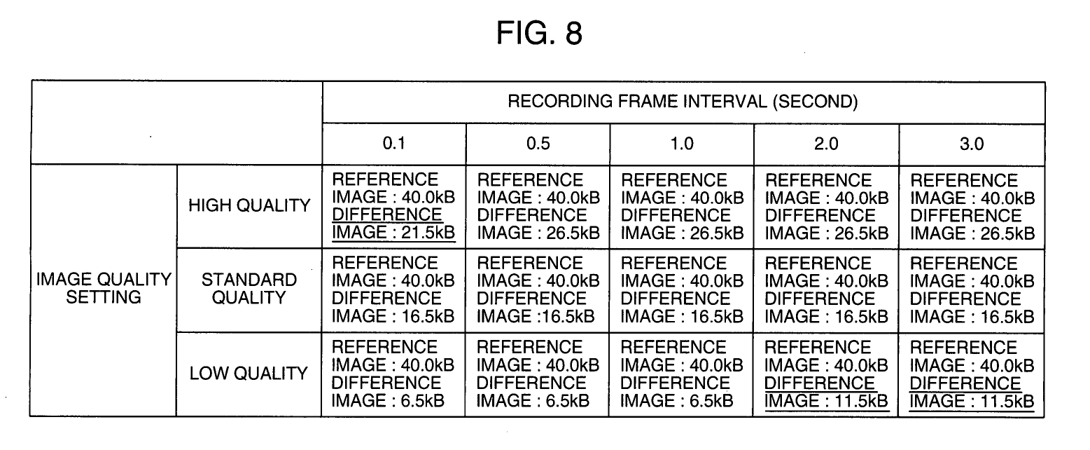

FIG. 8 shows an example of the quality settings and recording frame intervals in this invention. The wide frame interval is equivalent to relatively quick-varying of image. On the contrary, the narrow frame interval is equivalent to relative slow varying of image. Thus, the number of bits for the difference image is changed in one or some of the frame intervals by considering the above relative slow varying of image. Even if the user sets the cameras for high quality, the controlling microcomputer 105 automatically sets the cameras when the frame interval is 0.1 second so that the number of bits for the difference image can be adjusted to 21.5 kB that is slightly smaller than the original number for high quality, or 26.5 kB. Thus, the recording time can be more extended with the quality kept constant. Moreover, even if the user sets the camera for low quality, the controlling microcomputer 105 automatically sets the cameras when the frame interval is 2.3 seconds or 3.0 seconds so that the number of bits for the difference image can be adjusted to 11.5 kB that is larger than the original number for low quality, or 6.5 kB. Thus, the recording time can be extended with the quality deterioration suppressed.

Although three qualities and five frame intervals are shown above, more kinds of qualities and frame intervals will increase the degree of freedom, and thus the user is more easy to set the cameras for desired quality and recording time.

Thus, according to this embodiment about the apparatus for processing the image inputs from a plurality of channels by the single-channel compression/encode module, the number of bits for the reference image is constant, but the number of bits for the difference image is decreased, thereby reducing the total recording rate. Thus, even if the user sets the slow-image-varying channels, or cameras for low quality so as to record for a longer time, the image quality can be improved. In addition, when the recording frame interval is selected to be wide, the number of bits for the difference image is increased so that the recording time can be extended with the image quality not degraded.

While camera signals are inputted from four channels in this embodiment, the number of connected cameras is not limited to four. For example, the invention can be applied to the cases of a single camera, or one channel, and five cameras or more.

This invention can be applied to monitors that can record for a long time with the image quality maintained higher when the images on the cameras vary slowly.

While we have shown and described an embodiment in accordance with our invention, it should be understood that the disclosed embodiment is susceptible of changes and modifications without departing from the scope of the invention. Therefore, we do not intend to be bound by the details shown and described herein but intend to cover all such changes and modifications to fall within the ambit of the appended claims.

1. An image signal encoding apparatus comprising:
a selecting module which selects one of input image signals fed from a plurality of channels in synchronism with the frame of said input image signals and converts said input image signals into a single-channel image signal;
a sorting module which sorts said image signals of said single-channel image signal to be a group of a fixed number of frames for each channel;
an encoding module which compresses and encodes each of said groups of frames of said sorted image signals; and
a controlling module which controls the numbers of bits for reference image and difference image derived by said encoding module to be fixed as target values, whereby
a plurality of combinations of said target numbers of bits for said reference image and for said difference image can be obtained and used to make image quality setting when an image quality is fixed.

2. An image signal encoding apparatus according to claim 1, wherein a combination table for said combinations of said target numbers of bits is provided to have constant target numbers of bits for said reference image but variable target numbers of bits for said difference image depending upon a fixed image quality.

3. An image signal encoding apparatus according to claim 1, wherein an image quality for each input channel can be selected.

4. An image signal encoding apparatus according to claim 1, wherein the frame interval of said image signal encoded on each channel can be dynamically changed, and the image quality is changed according to the frame interval.

5. An image signal recording apparatus comprising:
a selecting module which selects one of input image signals fed from a plurality of channels in synchronism with the frame of said input image signals and converts said input image signals into a single-channel image signal;
a sorting module which sorts said image signals of said single-channel image signal to be a group of a fixed number of frames for each channel;
an encoding module which compresses and encodes each of said groups of frames of said sorted image signals including reference images and difference images;
a controlling module which controls the numbers of bits for the reference image and difference image compressed and encoded by said encoding module to be fixed as target values; and
a recording module which records said compressed and encoded image signals on a medium, whereby
a plurality of combinations of said target numbers of bits for said reference image and for said difference image can be obtained and used to make image quality setting when an image quality is fixed.

6. An image signal recording apparatus according to claim 5, wherein a combination table for said combinations of said target numbers of bits is provided to have constant target numbers of bits for said reference image but variable target numbers of bits for said difference image depending upon a fixed image quality.

7. An image signal recording apparatus according to claim 5, wherein an image quality for each input channel can be selected.

8. An image signal recording apparatus according to claim 5, wherein the frame interval of said image signal encoded on each channel can be dynamically changed, and the image quality is changed according to the frame interval.
